(19) United States
(12) Patent Application Publication
(10) Pub. No.: US 2014/0316737 A1
(43) Pub. Date: Oct. 23, 2014

(54) METHOD FOR MONITORING INSIDE-BOILER DYNAMIC WALL TEMPERATURE OF POWER PLANT BOILER HIGH-TEMPERATURE PIPING SYSTEM

(71) Applicant: SHANGHAI WANGTE ENERGY RESOURCE SCIENCE & TECHNOLOGY CO., LTD., Shanghai, Shanghai (CN)

(72) Inventors: Heng Wang, Shanghai (CN); Menghao Wang, Shanghai (CN)

(73) Assignee: SHANGHAI WANGTE ENERGY RESOURCE SICENCE & TECHNOLOGY CO., LTD., Shanghai (CN)

(21) Appl. No.: 14/366,247

(22) PCT Filed: Dec. 7, 2012
(86) PCT No.: PCT/CN2012/086140

§ 371 Date: Jun. 17, 2014

(30) Foreign Application Priority Data
Dec. 19, 2011 (CN) 201110427921.2

(51) Int. Cl. G01K 1/02; G01K 13/02

(52) U.S. Cl. CPC G01K 1/026; G01K 13/02
USPC 702/130

(57) ABSTRACT

A method for real-time monitoring in-furnace wall temperature of the high temperature tube systems in utility boilers consists of: Performing pre-calculation and choosing some tubes as representative tubes according the in-furnace tube wall temperature margins in a tube bundle, then installing out-furnace wall temperature measuring points on the chosen tubes; reading data from a power plant real-time database, which are the real-time operational parameters and out-furnace temperatures necessary in the calculation; saving the data into the communication database in local servers; instant calculating the in-furnace steam temperatures and wall temperatures of superheater and reheater tube systems based on the measured real-time operational parameters of the boiler and the out-furnace wall temperatures; sifting out overheated tube segments as per allowable stress, and saving these data into comprehensive overheat database.

This application is the U.S. national phase of International Application No. PCT/CN2012/086140 Filed 7 Dec. 2012 which designated the U.S. and claims priority to Chinese Application Nos. 201110427921.2 filed on 19 Dec. 2011, the entire contents of each of which are hereby incorporated by reference.

### TECHNICAL FIELD OF THE INVENTION

The Invention relates to a method in the technical field of utility boilers, in particular to a method for on-line monitoring the in-furnace wall temperatures of the high-temperature tube systems in utility boilers.

### TECHNOLOGY BACKGROUND

In recent years, the utility industry has been developing rapidly in China. There are great amount of supercritical and ultra-supercritical utility boilers in operation, such as boiler grade, temperature and pressure are getting higher. Now metal materials utilized in boiler superheaters are almost of the top heat resistant grade, and the overheat margins of the materials are becoming narrower. During operation, many factors can cause overheat. In addition, the overheat of the material speeds up the oxidization scaling at tubes' inner surfaces, thus causes tube clogging and bursts due to blockage. The boiler tube bursts accidents could result a direct economic loss of tens million RMB, greatly reduce the service lifespan of the tube bundles. Therefore there exists some potential risk of frequent successive tube bursts. A method for on-line monitoring in-furnace tube wall temperatures of the superheater and reheater tube systems of the utility boiler is in urgent need in order to prevent the tube bursts due to overheat in superheaters and reheaters, and to decrease the generation rate of oxidization scaling in the tubes, as well as to prolong the service lifespan of tube bundles. The method for on-line monitoring the boiler's operational conditions, wall temperatures, temperature margins of the superheater and reheater tube systems of utility boilers might also be taken as practical guidance for tuning up the combustion in the boiler furnace. The method has prominent and impressive benefits in economy and environment, closely related to the goals of the state energy construction in the “12th Five-Year Plan” of China.

The following is the research results of the existing technical literature: [refer as ‘the Patent’ hereafter]

\textcircled{1} Title of the Patent: Smart wall temperature management method for the final-stage superheater and final-stage reheater of a utility boiler; Application No. of the Patent: 201010174298.X; Publication No. of the patent: CN101832543A. According to description of the patent, the management method comprises of:
Step 1. Linking a web server with a client browser, a database server and a computing server respectively, then linking the database server through the plant-level monitoring information system with the DCS system or MIS system and on-line measuring points;
Step 2: Reading the on-line monitoring data of the final-stage superheater and final-stage reheater of the boiler in the database of the plant-level monitoring information system, and saving the data into a local communication database;
Step 3: Calculate the steam temperature and tube wall temperature at each in-furnace calculating point according to the read on-line monitoring data;
Step 4: Calculating the historical temperature data distribution range and the time duration of operation under overheating for all calculating point of each tube and each panel in the final-stage superheaters and final-stage reheaters;
Step 5: Display the calculation results in real-time.

The patent has the following deficiencies: (1) As per the theme of the patent, the wall temperatures of only two tube bundles in the boiler, i.e. final-stage superheater and final stage reheater, were under its management. However there are usually six tube bundles altogether for the superheater/reheater systems in a large boiler, i.e. the 1st stage superheater (low temperature superheater), the 2nd stage superheater (partition panel superheater), the 3rd stage superheater (rear panel superheater), 4th stage superheater (last stage superheater), the low temperature reheater and the high temperature reheater. Actually there are approximate 30˜40% of tube bursts due to overheat occurred at the 1st stage and/or 2nd stage superheaters, but the patent did not consider the problem of the tube bursts due to overheat at either the 1st stage or 2nd stage superheaters; (2) In step 1 and 2 of the patent, there are neither selection nor layout of the measured points for obtaining the monitored data, which are related with the technical plan and measure for improving accuracy and reliability of the measurement. Therefore the patent lacks any complete basis for calculating steam temperature and in-furnace wall temperature of the calculating and monitored points in the furnace, and is hardly to conform to the actual boiler operating conditions. If tubes with the highest temperature were not chosen as the measured and monitored points, the measured parameters would be not proper enough for the calculation of the steam temperature and in-furnace wall temperature of monitored points. The improper results would ruin the entire technical procedure badly; (3) In step 3 of the patent, there lacks any modeling basis for calculation of steam temperatures and wall temperatures of each monitored points, too. Therefore the calculation results would hardly conform to the actual boiler operating conditions. For example, the patent did not take all radiation heat transfer modes into account. There actually exist several modes of gas radiation that should be included, such as the upstream panel-interval gas radiation (before-front radiation), in-panel gas radiation and back radiation. The deviations of heat absorption, such as the convective deviations among tube rows, radiation deviations among panels, and radiation deviations upstream and downstream of the panels were not included as well.

In summary, the patent could not perform the fast, on-line, and real-time calculation, or the on-line monitoring and controlling the wall temperature of all high temperature tube bundles in boiler, and was unable to achieve the goal of safety operation, and to extend the lifespan of boiler. Because there lacks any model basis, it is hardly to expect for neither good measuring accuracy and reliability, nor the desired technical effects as described, even for the specified last stage superheater and reheater.

Contents of the Invention [Refer as ‘the Invention’ Hereafter]

The Invention proposed a new method of on-line monitoring the in-furnace wall temperature of high temperature tube systems in utility boilers. The new method has eliminated all deficiencies and the shortages of existing techniques. The Invention performs on-line calculating and monitoring the overheat status for the tube bundles of superheater and reheater, and achieves the safe and economic operation of boilers. Consequently, the Invention provides a direct data support to the boiler maintenance.

The Invention is achieved through the following technical procedure:

The Invention includes the following steps:

Step 1: Based on a pre-calculation, choose some tubes as representative of the tube bundles as per minimum in-furnace tube wall temperature margins, and then install out-furnace wall temperature measured points on the chosen tubes.
Step 2: Read the data of the boiler operating parameters, out-furnace wall temperature from the real-time power plant database, which are necessary for further calculations, and then save them into communication database of local server;
Step 3: Calculate the real-time working medium temperatures, in-furnace wall temperature, and overheat as per the allowable stress of all tube segments in superheater and reheater tube systems based on the data of boiler real-time operation parameters and measured out-furnace wall temperatures.
Step 4: Sift out the data of overheat (as per the allowable stress) from the calculated results at step 3, then display on-time and save them into the comprehensive overheat database.
Step 5: Ascending sort the monitored tube segments as per their overheat frequency, overheat amplitude, overheat time duration, etc. Then display the distribution profiles of the above parameters graphically in diagrams and/or in tabulations automatically,

Wherein, the pre-calculation stated in Step 1 means to seek out the tubes which are most likely to suffer from overheat or bursts in tube bundles, based on boiler design calculation. The calculation considered the most deviation of heat absorption along boiler width, then predicted the wall temperature margins as per the allowable stress of each tube.

To obtain the above mentioned wall temperature margin as per the allowable stress of metal, the following steps shall be carried out:

a. Calculate the average convective heat of the tube segment, Q_{d}:

Q_{d}=ξ_{d}KₕKᵣα_{d}H_{d}(θ−t₃) (1)

where—ξ_{d}—convection heat deviation coefficient; Kᵣ—width heat flux deviation coefficient; Kₕ—height heat flux deviation coefficient; α_{d}—convective heat transfer coefficient; H_{d}—convective heat absorption area; θ—gas temperature, t₃; ash surface temperature.

According to the position of the calculated tube segments in the panel, determine the convection heat transfer deviation coefficient ξ_{d} of each row due to the convection heat transfer deviation caused by gas flushing.

b. Calculate the average panel-interval gas radiation heat (the radiation from the gas chamber between adjacent panels to a panel), Qₚ:

Qₚ=ξₚKₕσ₀aₓᵢaₚHₚ[(θ+273)⁴−(t₃+273)⁴] (2)

where: ξₚ—panel-interval gas radiation deviation coefficient; Kₕ—height heat flux deviation coefficient; σ₀—Boltzmann radiation constant; aₓᵢ—system radiation blackness; aₚ—panel-interval gas blackness; Hₚ—panel-interval gas radiation area; θₚ—panel-interval gas temperature between panels; t₃—ash surface temperature.

Calculate the panel-interval gas radiation heat deviation coefficients ξₚ of tube segments based on the angle coefficients from panel-interval gas chamber to the segments at different positions (the front tube, the medial tubes, tubes nestled up against sides of panel, tubes with different pitches at both sides).

c. Calculate the average front radiation heat of the panel (the radiation from the gas chamber before panels to a panel), Q_{q}:

Q_{q}=ξ_{q}Kₕσ₀aₓᵢa_{q}H_{q}[(θ_{q}+273)⁴−(t₃+273)⁴] (3)

where: ξ_{q}—front radiation deviation coefficient of panels; Kₕ—height heat flux deviation coefficient; σ₀—Boltzmann radiation constant; aₓᵢ—system radiation blackness; a_{q}—gas chamber blackness before panels; H_{q}—front radiation area; θ_{q}—front gas chamber temperature, t₃—ash surface temperature.

Calculate the front radiation deviation coefficients ξ_{q} of each tube segment in panel based on the positions of tube segment stream-wise (1^{st}, 2^{nd}, 3^{rd}, . . . row) and the angle coefficients from the front gas chamber to calculated segment,

d. Calculate the average before-front gas radiation heat (the radiation from the panel interval gas chamber before the front gas chamber to a panel), Q_{qq}:

Q_{qq}=ξ_{qq}Kₕσ₀aₓᵢa_{qq}(1−x_{gp})(1−a_{q})H_{qq}[(θ_{qq}+273)⁴−(t₃+273)⁴] (4)

where: ξ_{qq}—before-front radiation deviation coefficient; Kₕ—height heat flux deviation coefficient; σ₀—Boltzmann radiation constant; aₓᵢ—system radiation blackness; a_{qq}—before-front gas chamber blackness; x_{gp}—radiation angle coefficient from before-front gas chamber to panel entry tube row; a_{q}—front gas chamber blackness; H_{qq}—before-front radiation area of panel; θ_{qq}—before-front gas chamber temperature; t₃—ash surface temperature.

Calculate the before-front radiation deviation coefficient ξ_{qq} based on the angle coefficient from before-front gas chamber (previous panel-interval gas chamber upstream), through the front gas chamber and entry tube row plane to calculated tube segments.

e. Calculate the average in-panel gas radiation heat (the radiation from the gas chamber enclosed by the middle tube loops to a panel) Q_{z}:

Q_{z}=ξ_{z}Kₕσ₀aₓᵢa_{z}H_{z}[(θ_{z}+273)⁴−(t₃+273)⁴] (5)

Where—ξ_{z}—in-panel radiation deviation coefficient; Kₕ—height heat flux deviation coefficient; σ₀—Boltzmann radiation constant; aₓᵢ—system radiation blackness; a_{z}—in-panel gas chamber blackness; H_{z}—in-panel radiation area; θ_{z}—in-panel gas chamber temperature; t₃—ash surface temperature.

Calculate the in-panel radiation deviation coefficients ξₚ of each tube segment in panel based on the positions of tube segment stream-wise (1^{st}, 2^{nd}, 3^{rd}, . . . row) and the angle coefficients from the in-panel gas chamber to calculated segment,

f. Calculate the average back radiation heat (the radiation from the gas chamber after panels to a panel) Qₕ,

Qₕ=ξₕKₕσ₀aₓᵢaₕHₕ[(θₕ+273)⁴−(t₃+273)⁴] (6)

where: ξₕ—deviation coefficient of back radiation; Kₕ—height heat flux deviation coefficient; σ₀—Boltzmann radiation constant; aₓᵢ—system radiation blackness; aₕ—back gas chamber blackness; Hₕ—back radiation area; θₕ—back gas chamber temperature; t₃—ash surface temperature.

Calculate the back radiation deviation coefficients ξₕ of each tube segment in panel based on the positions of tube segment stream-wise (1^{st}, 2^{nd}, 3^{rd}, . . . row) and the angle coefficients from the back gas chamber to calculated segment,

g. Calculate the average underneath radiation heat (the gas radiation from the chamber under panels to a panel) Qₓ:

Qₓ=ξₓKₕσ₀aₓᵢaₓHₓ[(θₓ+273)⁴−(t₃+273)⁴] (7)

where: ξₓ—underneath radiation deviation coefficient; Kₕ—height heat flux deviation coefficient; σ₀—Boltzmann radiation constant; aₓᵢ—system radiation blackness; aₓ—underneath gas blackness from furnace or gas chamber; Hₓ—underneath radiation area; θₓ—underneath gas temperature; t₃—ash surface temperature.

Calculate the underneath radiation deviation coefficients ξₓ of each tube segment in panel based on the positions of tube segment stream-wise (1^{st}, 2^{nd}, 3^{rd}, . . . row) and the angle coefficients from the underneath gas chamber to calculated segment,

h. Calculate the enthalpy increment Δiₐ in the tube segment,

Δiₐ=Kᵣ^{y}(Q_{d}+Qₚ+Q_{q}+Q_{qq}+Q_{z}+Qₕ+Qₓ)/ga (8)

Where—Kᵣ^{y}—width heat absorption deviation in pre-calculation; Q_{d}—average convection heat of the tube; Qₚ—average panel-interval gas radiation heat; Q_{q}—average front radiation heats; Q_{qq}—average before-front radiation heat; Q_{z}—average in-panel radiation heat; Qₕ—average back radiation heat; Qₓ—average underneath radiation heat; ga—steam flow of calculated tubes.
i. Calculate the steam enthalpy i of the tube:

i=iⱼ+ΣΔiᵢ (9)

where: iⱼ—inlet steam enthalpy of the calculated tube segment, using the design parameters; ΣΔiᵢ—sum of all steam enthalpy increments calculated for all the tube segments from the tube inlet to the calculated points.
j. Calculate the working medium temperature in the calculated tube segments, t:

Using the Enthalpy-Temperature diagram or table, obtain t based on i.

k. Calculate the maximum heat flux along the tube outer periphery of the segment, qₘ:

qₘ=ΘQ_{d}/H+φ(Qₚ/Hₚ+Q/H_{q}+Q_{qq}/H_{qq}+Q_{z}/H_{z}+Qₕ/Hₕ+Qₓ/Hₓ) (10)

where: η—magnifying coefficient of convectional heat flux; Q_{d}—convectional heat; H_{d}—convectional heat absorption area; φ—heat radiation exposure coefficient; Qₚ—panel-interval gas radiation heat; Hₚ—panel-interval gas radiation area; Q_{q}—front radiation heat; H_{q}—front radiation area; Q_{qq}—before-front radiation heat; H_{qq}—before-front radiation area; Q_{z}—in-panel gas radiation heat; H_{z}—in-panel radiation area; Qₕ—back radiation heat; Hₕ—back radiation area; Qₓ—underneath radiation area; Hₓ—underneath radiation area.
l. Calculate the inner wall temperature of the tube segments, t_{nb}:

t_{nb}=t+βqₘ(μₙ/α₂) (11)

where: t—working medium temperature at calculated segments; β—ratio of outside diameter to inner diameter; μₙ—heat flux diversion coefficient at inner surface; α₂—heat transfer coefficient from inner surface to steam; qₘ—maximum heat flux along tube's out periphery.
m. Calculate wall temperatures of the tube segments t_{b} (at the points halving thermal resistance),

t_{b}=t+βqₘ[μₙ/α₂+δμₚⱼ/λ(1+β)] (12)

where: t—working medium temperature of calculated segment; β—ratio of outer diameter to inner diameter; qₘ—maximum heat flux along tube segment outer periphery; μₙ—heat flux diversion coefficient at inner surface; μₚⱼ—average heat flux diversion coefficient through the wall thickness; α₂—heat transfer coefficient from inner surface to steam; λ—conduction coefficient of the metal; δ—tube wall thickness;
n. Calculate the metal allowable temperature of the monitored tube t_{yx},

t_{yx}=f(σ_{dt}) (13)

where: σ_{dt}—stress of tube segment at calculated point.
o. Calculate the wall temperature margin δt as per the allowable stress of tube metal,

δt=t_{yx}−t_{b} (14)

where: t_{b}—wall temperature at the points halving thermal resistance; t_{yx}—allowable temperature of tube metal.

The procedure for choosing the measured tubes by pre-calculation stated in Step 1 is as follows:

\textcircled{1}Through pre-calculation to seek out the tubes which are the most likely to suffer from bursts due to overheat;
\textcircled{2}Ascending sort the tube wall temperature margins, and the Invention choose the first 100 tubes needed to be monitored, which are with the narrowest margins and scattered along the width and depth of boiler gas duct, and then selects 5-20% of the total tubes in boiler from the above chosen 100 tubes to install out-furnace all temperature measured points while the layout of the measured points is planned.

The Invention calculates the real-time working medium temperatures of the monitored tube segments based on theoretical studies and on-site measurement. It is necessary to consider all kinds of heat transfer modes, including convection heat Q_{d}, panel-interval gas radiation heat Qₚ, front radiation heat Q_{q}, underneath radiation heat Qₓ, before-front radiation heat Q_{qq}, in-panel radiation heat Q_{z} and back radiation heat Qₕ. However all existing techniques only took the former four heat transfer modes into account.

Nowadays, the boiler capacity is getting larger and the boiler structure is quite different from previous sub-critical utility boiler. Therefore the latter three heat transfer modes can not be neglected and should be added onto calculation of steam temperatures in segments. Counting in the three heat transfer modes in calculation of steam temperature will elevate the calculated steam temperature for the outmost few tubes, and thus in better conformity with on-site measurements.

All existing techniques utilize a fixed convectional heat transfer coefficient α_{d} for all tube rows in tube bundles in steam temperature calculation. However, the current reality is that compact panels with longitudinal pitch ratio S₂/d=1.3˜2 are widely used for the superheater and reheater tube systems in large capacity utility boilers. For the compact panels, gas flow could not impinge straight on the medial rows of tubes, while the front-edges of first row tubes and the rear-edges of the last row tubes are well flushed by gas flow since both edges are not sheltered by adjacent tubes in the gas flow direction so that the local α_{d} should be larger than that for the medial tube rows. Therefore the Invention utilizes layer theory to analyze local the gas velocity and local convective heat transfer coefficient around the calculated tube segments, and then integrates the local values to calculate the convectional heat transfer deviation coefficients ξ_{d} for the tube segments. The improvement provides more accurate results of the calculation.

All existing techniques calculate the steam temperature at different points in boilers still using a constant average panel-interval gas radiation heat flux qₚ for all tubes along the gas flow paths. But the current reality is that the loyal panel-interval radiation heat fluxes are of large differences among the tubes as per their positions (the front tube, the medial tubes, tubes nestled up against sides of panel, tubes with different pitches at both sides, etc.). The authors of the Invention have investigated and calculated of the panel-interval radiation angle factor to the tubes with different shapes, then carried out multiple integral to calculate the panel-interval gas radiation deviation coefficient ξₚ, thus improved the calculation accuracy, too.

It is so difficult for the existing techniques to calculate the local steam temperatures t within the tube segments, so that an average steam temperature tₚⱼ is employed rather than the local temperatures t to calculate average heat flux q₀, which is multiplied by width heat deviation coefficient Kᵣ to get the maximum heat flux qₘ along the tube outer periphery of the segment. However such a calculated heat flux q₀ would be much higher than the actual heat flux since the steam temperatures t in deviated tubes are much higher than the average temperature tₚⱼ. This situation leads to significant errors between the calculation results of wall temperature and real status. The Invention calculates the steam temperatures and inner wall temperatures of tube segments in furnace at the monitored points of each tube in each panel in the boiler based on real-time operating parameters of boiler and measured out-furnace wall temperatures so that the calculated steam temperatures and in-furnace wall temperatures are more accurate. The calculated results are in good conformance with onsite measurement as is improved the calculation procedure.

The existing techniques use a unique heat flux diversion coefficient μ a in the calculation of wall temperatures of the tubes in boilers. But the steam temperature and pressure in the superheaters and reheaters of modern large-capacity boilers are much higher than those of subcritical boilers. For example, the steam pressure at the superheater outlet in the ultra supercritical boiler is around 50% higher than that in subcritical boilers, as high as 26˜27.5 MPa·g, the steam temperature at superheater outlet in ultra supercritical boilers reached 605° C., i.e. 35° C. higher than that in subcritical boilers. Therefore, the tube wall would become much thicker. For example, the tube wall thickness of final superheater in ultra supercritical boiler are 40˜50% thicker than that in subcritical boilers and may reach 7˜11 mm. So, a great difference would show off as comparing heat flux diversion coefficient at the inner surface with the average heat flux diversion coefficient μₚⱼ over the entire wall thickness.

The Invention utilizes a mathematical model of heat diverging along the tube wall to calculate the heat flux diversion coefficient μₙ at the inner surface and the average heat flux diversion coefficient μₚⱼ over entire wall thickness respectively. Both the diversion coefficients are employed to calculate the tube wall temperatures (at the points halving thermal resistant). Thus the calculation accuracy gets better. Meanwhile, the wall stress is varying from the outer surface to inner surface while the tube is subjected to an internal pressure. According to the principles of material mechanics, the position characterizing the strength of the tube should be the point halving thermal resistant, so tube segment temperature at the points halving thermal resistance are properly chosen as indicator to judge whether the wall temperature has reached overheat condition. Therefore, the accuracy of the calculation can get improved again.

Step 2 stated a procedure to save data to communication database at local server as is follows:

\textcircled{1} Choose the boiler real-time operating data, lists of monitored points of out-furnace wall temperature in superheaters and reheaters from the KKS list supplied by the plants;
\textcircled{2} Compose a program to collect data through API interface, send commands to the local computing server to request the real-time database to read data as per the list of monitored points and produce data files according specified format;
\textcircled{3} The plant real-time database sends the requested data twice per minute and save them with assigned file name to the assigned location of the local computing server;
\textcircled{4} Save the data timely to the real-time database of the local server or the communication database.

Step 3: Calculate the working medium temperatures and the tube wall temperatures on time, comprising the following steps:

\textcircled{1} Calculate the real-time working medium temperature, inner wall temperature and wall temperatures at the points halving thermal resistance of the monitored tube segments of all panels in boiler;
\textcircled{2} Calculate the overheat as per the allowable stress of tube metal;
\textcircled{3} Display the working medium temperatures, wall temperatures (at the points halving thermal resistance), the overheat as per the allowable stress of tube metal, overheat and material specifications of monitored tube segments of superheaters and reheaters in boilers with line chart, vector diagram and histogram combining the mouse pointer respond mode.

The step \textcircled{1} stated the calculation of real-time working medium temperatures, the inner wall temperatures and the wall temperatures of the calculated tube segments, the steps of the calculation are:

a. Calculate the average convection heat Q_{d} of the tube segment; the average panel-interval radiation heat, Qₚ; the average front radiation heat Q_{q}; the average before-front radiation heat, Q_{qq}; the average in-panel radiation heat Q_{z}; the average back radiation heat Qₕ; the average underneath radiation heat, Qₓ, of the calculating tube segments. The above mentioned seven modes of heat absorptions are calculated through equations (1) to (7) above.
b. Calculate the width deviation coefficient Kᵣ of heat absorption in actual operating conditions:

Kᵣ=Qⱼₛ/Qₚⱼ (15)

where: Qⱼₛ: heat absorption of calculated panel, Qₚⱼ: average heat absorption of panels.
c. Calculate the enthalpy increment of the tube, Δiₐ:

Δiₐ=Kᵣ(Q_{d}+Qₚ+Q_{q}+Q_{qq}+Q_{z}+Qₕ+Qₓ)/ga (16)

where: Kᵣ; width heat deviation coefficient in real operating conditions; Q_{d}—average the convection heat; Qₚ—average panel-interval radiation heat; Q_{q}—the average front radiation heat; Q_{qq}—average before-front radiation heat; Q_{z}—average in-panel radiation heat; Qₕ—average back radiation heat; Qₓ—average underneath radiation heat; the above seven heat are calculated by equations (1) to (7) and Kr—by equation (15); ga—steam flow of the calculated tube segment.
d. Calculate steam enthalpy i and temperature t of working medium of tube segment:

i=iⱼ+ΣΔiᵢ (17)

where: iⱼ—inlet steam enthalpy of the panel during operation; ΣΔiᵢ—sum of calculated steam enthalpy increments of all the tube segments from its inlet to the monitored point.
e. Determine the working medium temperature t at monitored point.

Find the temperature t based on the enthalpy i using an enthalpy-temperature diagram or table.

f. Calculate the maximum local heat flux qₘ around the outer periphery of the tube using equation (10).
g. Calculate the wall temperatures t_{nb} at inner surface of the monitored point and wall temperature t_{b} (at the point halving heat resistant). These two items are calculated by above equations (11) and (12).

To obtain overheat as per the allowable stress of the tubes as per Step \textcircled{2}, the procedure is as follows:

h. Calculate the allowable metal temperature t_{yx} at given stress.

t_{yx}=f(σ_{dt}) (18)

where: σ_{dt}—the stress of the tube at the calculated point.
i. Calculate the overheat dt as per the allowable stress of tube metal,

dt=t_{b}−t_{yx} (19)

where: t_{b}—wall temperature; t_{yx}—allowable temperature of tube metal.

In step \textcircled{3}, displaying the working medium temperature, wall temperature (at the point halving thermal resistance), the metal overheat as per the allowable stress of the tube, material and specification at each monitored point of the superheater and reheater systems means:

An operator may choose the option—“Displaying the distribution profiles of steam temperature and wall temperature” in format of ‘all panels’ or ‘all tubes in a panel’ from the menu of “Steam temperature monitor and alarm”. The screen would show the chosen distribution profiles of steam temperatures and wall temperatures respectively. Once there appeared overheat as per the allowable stress, the corresponding graphic figures would change color from blue to red for alarming. When the mouse pointer is clicked on a bar graph, there would show the related data, such as the location, the medium temperature, wall temperature, overheat as per the allowable stress, the overheat, material and specification of the current tube segment.

As the Step 4 stated, saving the data into the “comprehensive overheat database” includes the recorded and displayed parameters such the accumulative overheat time-duration, overheat, overheat frequency and the boiler operating parameters at the moment when overheat happens. The steps are as follows:

\textcircled{1} Overheat as per the allowable stress (the wall temperature gets higher than the allowable temperature as per local stress) would trigger on the start of a one-hour record for all parameters related to overheat. The data record should be written into the database, including the boiler's power output (in MW), the main steam temperature, the highest wall temperature, the overheat time (moment and duration), material, specification, etc. Thenafter the data will be available for inquiring about the overheat statistics and analysis of tube bundles.
\textcircled{2} Compose desired scatter point diagram, vector diagram, histogram and/or tabulation, while the overheat frequency, overheat, and the overheat time duration are taken as the ordinates and the panel serial numbers as abscissa, in order to illustrate the distribution profiles (or table) of the overheat frequency, overheat amplitude, and overheat time for the first 100˜800 tube segments.
\textcircled{3} When the mouse pointer overhangs on any scatter point, a data box will appear on screen. The box contains the information of location of the monitored tube segment, its material and specifications and the overheat time (moment and duration).

The operator opens “Overheat Statistics” menu and selects the desired panels, there will appear an “Overheating Statistics” interface for the chosen panel. Its tabulation illustrates the historical details of overheat of tube segments in previous operating period, including the accumulated overheat duration, overheat details, locations of overheated tube segment, tube material and specifications, etc., and all information could also be arrayed in sequence of tubes' or panels' serial numbers and displayed on user end interface. A corresponding data sheets could be output in EXCEL format as requested.

Click on the button “View” after an overheat record, the system will open “History Trace Back” page of the present overheat record to review the process of the wall temperature's rising and reaching its peak value. The upper part of the table has some fuzzy query boxes where the query conditions may be put in requesting overheat details of any panel. In the tabulation “Comprehensive Overheat Query” the operator may choose some inquiring options such as overheat's time (start/end moments and duration), overheat panel's serial number, etc. for a integrated inquiring about overheat's status. The inquired data can output as files in format of EXEL. User can also carry out a combination query by selecting the different tube bundle, the length of time of the overheated range, the over-temperature location, the overheat date. The system will visit the database to show the overheat history, etc; and the information will display at the user's interface after summarization according to the conditions.

The step \textcircled{5}specified some distribution profile diagrams including overheat, overheat time duration, overheat frequency, etc.

The user could compose desired scatter diagram, vector diagram and/or tabulation, while overheat frequency, overheat, and overheat time are taken as the ordinates and the panel serial numbers as abscissa, in order to illustrate the distribution profiles (or table) of overheat frequency, overheat status, overheat time for the first 100˜800 monitored tube segments.

The Invention firstly conducts a real-time, on-line monitoring the operation conditions, wall temperatures and overheat range on the superheater and reheater systems in utility boilers in order to eliminate the tube bursts in utility boilers' superheater and reheater systems due to overheat as per the allowable stress and to prolong the lifespan of panels, and then establishes the models for calculation, and also provides method to avoid operational overheat and to prolong lifespan based on the actual measured data and calculated results.

The Invention composes a procedure for prolonging the lifespan of the boiler superheater and reheater systems could achieve the real-time on-line monitoring of the wall temperatures of all tube systems in boilers and overheat as per the allowable stress. If there are some abnormal temperature conditions, such as either too-high or too-low temperature zones, appearing in some tube bundles of superheaters and reheaters, the operator may tune up the combustion in boiler furnace utilizing available tools, such as adjusting direction of tangential secondary combustion air, changing operational configuration of the coal pulverizers and burners, etc. Therefore it is likely to prevent against abnormal temperature conditions, either too high or too low temperature, to alleviate the oxidized scaling, to mitigate overheat and bursts and to prolong the lifespan of tube bundles.

The Invention offers significant technical advantages and economical benefits over other existing techniques: (1) the Invention monitors all stages of superheaters and reheaters, as is quite different from other existing techniques that monitor only last stage superheater and reheater. The Invention spreads the protection coverage over all the superheaters and reheaters instead of only one stage of them; (2) the Invention carefully chooses points for measuring out-furnace wall temperatures and planning their layout. Therefore the accuracy and reliability of the calculation would be improved; (3) The Invention makes up some radiation modes such as before-front radiation, in-panel radiation and back radiation in addition to convection and other radiation modes based on the features of modern boilers with ultra-large capacity so that calculated steam temperatures are in better consistent with the monitored and measured results; (4) The Invention calculates maximum heat flux qₘ directly based on the real-time measured steam temperatures and flue gas temperatures at monitored points, and introduces the average heat flux diversion coefficient μₚⱼ and heat flux diversion coefficient μₙ at inner wall surface to reflect the effect of thicker tube wall. Thus the calculation could offer much more accurate results than ever before. (5) The Invention performs the on-line calculating and monitoring of wall temperature, overheat margin as per the allowable stress so that it can eliminate the bursts due to overheat as per the allowable stress in superheater and reheater tube system in boilers. The major technical effect is to prolong lifespan of the tubes. The Invention has solved one of the most important technical problems. Therefore it is possible to set up proper preventive procedure against tube bursts in high temperature tube systems and to minimize the enormous economic losses.

The specific beneficial indicators are as follows:

The benefit analysis of boiler shutting down and re-starting: Assume that the boiler of 1,000 MW could avoid an abnormal shut-down and restart once per year, the power plant would save six days for abnormal shut-down and restart maintenance, the benefit based on the load rate of 60% and profit rate of ¥0.1 RMB could be shown in following table:

(The data here do not include the penalty by Grid Administration for unpredicted boiler shut down)

| | Benefit due to an abnormal | | |
|---|---|---|---|
| | reducing start/shout down | | |
| Generator | Reducting cost | | Total reduction |
| Capacity, | for shut down/ | Extra power | of economical |
| (Pressure Rank) | re-start | production | loss |
| 1,000 MW (ultra | ¥800,000 RMB | 86,400 MWh | ¥9,440,000 RMB |
| supercritical) | | | |
| 660 MW (ultra | ¥550,000 RMB | 57,030 MWh | ¥6,253,000 RMB |
| supercritical) | | | |
| 600 MW (sub | ¥500,000 RMB | 51,840 MWh | ¥5,684,000 RMB |
| supercritical) | | | |
| 300 MW | ¥250,000 RMB | 25,920 MWh | ¥2,842,000 RMB |
| (subcritical) | | | |

\textcircled{2} Economic benefits due to avoid of operation with reduced pressure—Taking a 1,000 MW boiler as example, its designed coal consumption rate is 280 g/kWh. The loss of operation with reduced pressure is calculated at the conditions of: a) Both of main steam's and reheat steam's temperature were 15° C. lower than that at Boiler Maximum Continuing Rating (BMCR), b) Average boiler load rate is at 75% BMCR; c) Annual operating period is 7,000 hours—

| Items | Annual value | Economic benefit |
|---|---|---|
| Coal saving (Std. coal) | 11,812 tons | ¥11,810,000 RMB |
| Emission reduction(CO₂) | 30,712 tons | — |
| Plant circulation heat | 0.75~0.8% reduction | |
| efficiency | | |

\textcircled{3} The economic benefit due to longer lifespan of the high-temperature superheater/reheater tube panels:

Take a 600 MW boiler as an example, the total steel comsuption of the boiler is about 25,000 tons, the pressured parts weight about 7,500 tons. Among them, the high grade alloyed heat-resistant steels for the hot panels weigh about 2,930 tons, the construction cost is more than ¥100,000,000 RMB with design lifespan of 100,000 hours. If the lifespan of high-temperature tube panel could be extended for 20,000 hours, a very impressive economic benefit, more than ¥20,000,000 RMB, might be reached. The price of imported alloys HR3C, SUPER304H is tripled and as high as ¥300,000 RMB per ton. Therefore to extend its lifespan and to improve economic efficiency are in a greater need.

\textcircled{4} Social benefits: the tube bursts of the utility boiler occurs very often in imported boilers, such as: the front panel superheater of an imported 600 MW boiler imported from FW (installed in a Power Station in China), the final superheater and final reheater of an imported 600 MW boiler imported from CE, (installed in Beilun Power Station in China) and the panel superheater of another imported 600 MW boiler from B&W, etc. According to the statistics, several hundred cases of tube bursts at superheaters/reheaters occurred annually within China. If the Invention is utilized to prevent accidents, the economic benefits would be very great, and could avoid the local economic losses due to tube bursts by overheat, especially, its social and indirect economic benefits are much more significant in the summer and winter peak season.

### BRIEF DESCRIPTION OF THE DIAGRAM

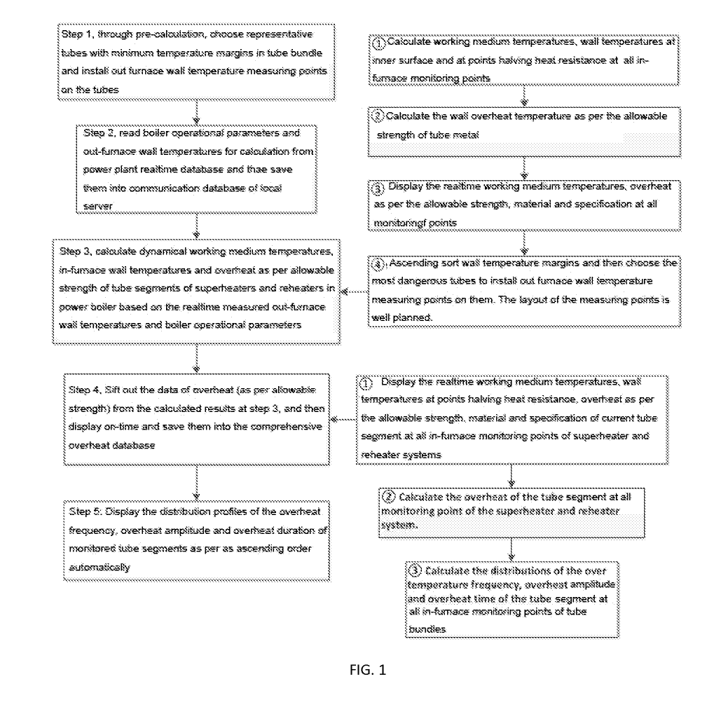

FIG. 1. Block diagram of the flowchart of the implement of the Invention.

### DETAILS FOR IMPLEMENTATION OF THE INVENTION

An interpretation of implementation of the Invention's procedure is given for an example case below combined with the attached diagram. However, the protection scope of the Invention is not limited to the case described below.

### Example Case

A 1,000 MW ultra-supercritical utility boiler is chosen as the example. Take its high temperature reheater to show the implement steps as the block diagram in FIG. 1

This implementation of the example case comprises of the following steps:

THE FIRST STEP: Through the pre-calculation, some tubes are chosen as representative of the hot reheater tube bundles based on minimum temperature margins as per the pre-calculated in-furnace wall temperatures. Then out-furnace wall temperature measuring points would be installed on the chosen tubes. The example 1,000 MW boiler has 44 panels of high temperature reheater, each panel has 24 tubes. There are 1,056 tubes and 6,336 calculated segments in total.

a. Calculate Enthalpy increment of the tube segment, Δiₐ:

Δiₐ=Kᵣ^{y}(Q_{d}+Qₚ+Q_{q}+Q_{qq}+Q_{z}+Qₕ+Qₓ)/ga

where: Kᵣ^{y}—width heat absorption deviation in the pre-calculation, Kᵣ^{y}=1.37 here; Q_{d}—average convection heat; Qₚ—average panel-interval gas radiation heat; Q_{q}—average front radiation heat; Q_{qq}—average before-front radiation heat; Q_{z}—average in-panel radiation heat; Qₕ—average back radiation heat; Qₓ—average underneath radiation heat; the above seven heats are calculated by equations (1) to (7), ga—steam flow of the calculated tubes.
b. Calculate the current steam enthalpy:

i=iⱼ+ΣΔiᵢ

where: iⱼ—inlet steam enthalpy of the calculated tubes, using the design value: 3,418 kJ/kg; ΣΔiᵢ—sum of all steam enthalpy increments calculated for all the tube segments from the tube inlet to the calculated point.
c. Calculate the working medium temperature at the calculating point,

Using the Enthalpy-Temperature diagram or table, obtain t based on i,

d. The inside wall temperature of the calculating tube segment, t_{nb}:

t_{nb}=t+βqₘ(μₙ/α₂)

where: t—working medium temperature at the calculation tube segment; β—ratio of outside diameter to inner diameter; μₙ—diversion coefficient of heat flux at inner surface; α₂—heat transfer coefficient at inner surface; qₘ—maximum heat flux along tube's out periphery.
e. Calculate wall temperature of the tube t_{b} (at the point halving thermal resistance),

t_{b}=t+βqₘ[μₙ/α₂+δμₚⱼ/λ(1+β)]

where: t—working medium temperature of the calculated tube; β—ratio of the outer diameter to inner diameter; qₘ—maximum heat flux along its out periphery; μₙ—heat flux diversion coefficient at the inner surface; μₚⱼ—average heat flux diversion coefficient through the wall thickness; α₂—heat transfer coefficient at inner surface; λ—conduction coefficient of the metal; δ—tube wall thickness;
f. Calculate the metal allowable temperature of the monitored tube,

t_{yx}=f(σ_{dt})

where: σ_{dt}—the stress of the tube at the calculated points
g. Calculate the wall temperature margins δt of tubes as per the allowable stress,

δt=t_{yx}−t_{b}

where: σ_{dt}—stress in the calculated tube; t_{b}—wall temperature of the tube (at the point halving thermal resistance)
\textcircled{2} Ascending sort the above wall temperature margins, then choose the first 100 tubes with the narrowest margins which scatters along the width and depth of boiler gas duct. Select 5-20% of the total tube in the boiler from the above chosen 100 tubes to install out-furnace wall temperature measured points. Then plan the layout for the monitored tubes.

There are 94 measured tubes in total, including all the 44 tubes at the fifth row of each panel from their front end, 18 tubes chosen from their first tube row of all panels, 12 tubes—form either the fifth panel or the fortieth panel respectively, in addition to the tubes which are likely to be jammed by foreign matter.

THE SECOND STEP: Read the real-time operation parameters of boiler, out-furnace wall temperature, etc. from the plant's VeStore real-time database (or other database, such as: PL [symbol] EDNA [symbol] openPlant [symbol] Golden), and then save them into the communication database at the local sever.

Compose a list of monitored points of necessary data (including the boiler real-time operating parameters, and out-furnace wall temperatures, etc. The data are needed for the calculation of steam temperatures and in-furnace wall temperatures.) from the KKS list supplied by the plants; Compose a program to collect data through API interface, send commands to the real-time database of plant's server to let the real-time database to transfer the data to the specified location of the local server as per the request list of monitored points, and then save the data files with specified format and data file names;

THE THIRD STEP: Calculate the real-time working medium temperature and in-furnace wall temperatures of the monitored points in the tube systems.

\textcircled{0} Calculating the working medium and metal temperatures of the monitored points based on the real-time data collected. Among them:
a. Calculate working medium enthalpy increment Δiₐ:

Δiₐ=(Q_{d}+Qₚ+Q_{q}+Q_{qq}+Q_{z}+Qₕ+Qₓ)/ga (16)

Where: Kᵣ—width absorption heat deviation coefficient in real operating conditions; Q_{d}—convection heat; Qₚ—panel-interval radiation heat; Q_{q}—front radiation heat; Q_{qq}—the before-front radiation heat; Q_{z}—average in-panel radiation heat; Qₕ—the back radiation heat; Qₓ13 the underneath radiation heat; The seven heat components here are calculated by equations (1) to (7), and Kᵣ—by equation (15). ga—steam flow of the calculated tube segment.
b. Calculate the steam enthalpy in the tube segments, i

i=iⱼ+ΣΔiᵢ

where: iⱼ—inlet steam enthalpy of the calculating tubes, using the design value; ΣΔiᵢ—sum of steam enthalpy increments calculated for all the tube segments from the tube inlet to the calculating point.
c. Calculate the working medium temperature in the calculating tube segments:

According to the Enthalpy-Temperature Diagram or Table, obtain t based on i,

In this example case the working medium temperatures of 6,336 pre-calculated tube segments scattered in the range of 460° C.˜620° C.

d. Calculate the inner wall temperature of the tube segment:

t_{nb}=t+βqₘ(μₙ/α₂)

where: t—steam temperature in the tube at the calculating point; β—the ratio of the outer diameter to the inner diameter of the tube; μₙ—the heat flux diversion coefficient at tube inner wall; α₂—the convection heat transfer coefficient at the inner wall; qₘ the maximum heat flux along tube outer periphery.
e. Calculate the maximum head flux along the outer periphery, qₘ of monitored points:

qₘ=ηQ_{d}/H_{d}+φ(Qₚ/Hₚ+Q_{q}/H_{q}+Q_{qq}/H_{qq}+Q_{z}/H_{z}+Qₕ/Hₕ+Qₓ/Hₓ)

where: η—convectional heat flux magnifying coefficient; Q_{d}—convectional heat; H_{d}—convectional heat absorption area; φ—the heat radiation exposure coefficient; Qₚ—in-panel radiation heat; Hₚ—in-panel radiation area; Q_{q}: front radiation heat; H_{q}—front radiation area; Q_{qq}—before-front radiation heat; H_{qq}—before-front radiation area; Q_{z}—in-panel radiation heat; H_{z}—in-panel radiation area; Qₕ—back radiation heat; Hₕ—back radiation area; Qₓ—underneath radiation heat; Hₓ: underneath radiation area.
f. Calculate wall temperature of the segment t_{b}:

t_{b}=t+βqₘ[μₙ/α₂+δμ_{Pj}/λ(1+β)]

where: t—working temperature of the calculated segment; β—ratio of the outer diameter to inner diameter; qₘ—maximum heat flux along segment outer periphery; μₙ—heat flux diversion coefficient at the inner surface; μₚⱼ—average heat flux diversion coefficient through the wall thickness; α₂—heat transfer coefficient at inner surface; λ—conduction coefficient of the metal; δ—tube wall thickness;

In this example case, the calculated in-furnace wall temperatures at the points halving thermal resistance for all 6,336 calculating points of the high-temperature reheater of the 1,000 MW ultra-supercritical boiler are in the range of 570˜660° C.

\textcircled{2} Calculate the tube wall overheat as per the allowable stress at all monitored points on time.
a. Calculate the allowable temperature t_{y}, of tube metal at the monitored points,

t_{yx}=f(σ_{dt}) (13)

where: σ_{dt} the stress of the tube at the monitored points.
b. Calculate the tube overheat of wall metal temperature as per local stress:

δt=t_{b}−t_{yx}

where: t_{b}—the tube wall temperature, and t_{yx}—the metal allowable temperature as per local stress
\textcircled{3} Display the working medium temperature, metal wall temperature, metal overheat temperature as per local stress, tube material and specification at all monitored point on time.

THE FOURTH STEP: Display the data of the overheated segments as per local stress on time and save the data in the comprehensive overheat database.

\textcircled{1} Display the working medium temperature, metal tube wall temperature (at the points halving thermal resistance), metal overheat as per local stress, material and specification of current tube segments at all monitored points of the superheater and reheater systems on time.
\textcircled{2} Calculate statistical data of the overheat of the tube segments at all monitored points of the superheater and reheater systems.
\textcircled{3} Calculate statistical data of the distribution profiles of the overheat frequency, overheat amplitudes, and overheat time of the tube segments at all monitored points of tube bundles in boiler.

The FIFTH STEP: Generate visual distribution profile diagrams and tables of the overheat amplitudes, overheat time and overheat frequency.

An operator might compose desired scatter diagrams, vector diagrams and/or tabulations while the overheat frequency, the overheat amplitude, and the time of the overheat are taken as the ordinates and the panel serial numbers—as abscissa in order to illustrate the distribution profiles (or table) of the overheat frequency, amplitude, time, etc. for the first 100˜800 tube segments. When the mouse pointer overhangs on any scatter point, a data box will appear on screen. The box contains the information of location of the monitored tube segment, its material and specifications, the overheat time (moment and period) and so on.

Economic and Social Benefits of this Example Case:

Monitoring the tube on-line wall temperatures of the 1,000 MW boiler can effectively control overheat of the high-temperature tube systems. Avoiding a tube bursts due to overheat could save a loss of ¥9.44 million RMB. The

Invention could also protect boiler from operations at reduced temperatures of superheated and reheated steam—for example—operating under temperatures reduced by 15° C. can increase the net coal consumption rate by 2.25 g/kWh and corresponding an extra need of 12,000 tons standard coal annually, that is ¥10 million RMB economic loss, It might reduce 34,000 tons CO₂ emission, 10.21 tons NOₓ, emission (based on 450 mg/Nm³), SOₓ, emission of 4.54 tons (based on 200 mg/ Nm³).

What is claimed is:

1. A method for on-line monitoring in-furnace wall temperature of high-temperature tube systems in utility boilers, comprising the following steps:
Step 1: based on a pre-calculation, choosing some tubes as representative of the tube bundles as per minimum in-furnace tube wall temperature margins, and then installing out-furnace wall temperature measured points on the chosen tubes;
Step 2: reading the data of the boiler operating parameters, out-furnace wall temperature from the real-time power plant database, which are necessary for further calculations, and then saving them into a communication database of local server;
Step 3: calculating the real-time temperatures of working medium, in-furnace wall temperature, and overheat as per the allowable stress of all tubes in superheater and reheater tube systems based on the data of boiler real-time operating parameters and measured out-furnace wall temperatures;
Step 4: sifting out the data of overheat (as per the allowable stress) from the calculated results at step 3, then display on-time and saving them into the comprehensive overheat database;
Step 5: ascending sorting the monitored tube segments as per their overheat frequency, overheat amplitude, overheat time duration, etc., then displaying the distribution profiles of the above parameters graphically in diagrams and/or in tabulations automatically.

2. The method according to claim 1, wherein the pre-calculation stated in Step 1 refers to seeking out the tubes which are suffered from overheat or bursts in tube bundles, based on boiler design calculation, and the calculation considered the most deviation of heat absorption along boiler width, then predicted the wall temperature margins as per the allowable stress of each tube.

3. The method according to claim 2, wherein obtaining the above mentioned wall temperature margin as per the allowable stress of metal comprising the following steps:
a. calculating the average convective heat of the tube segment, Q_{d}:
Q_{d}=ξ_{d}KₕKᵣα_{d}H_{d}(θ−t₃) (1)
Wherein ξ_{d} as convection heat deviation coefficient; Kᵣ as width heat flux deviation coefficient; Kₕ as height heat flux deviation coefficient; α_{d} as convective heat transfer coefficient; H_{d} as convective heat absorption area; θ as gas temperature, t₃; ash surface temperature;
b. calculating the average panel-interval gas radiation heat Qₚ:
Qₚ=ξₚKₕσ₀aₓᵢaₚHₚ[(θ+273)^{4 as}(t₃+273)⁴] (2)
wherein ξₚ as panel-interval gas radiation deviation coefficient; Kₕ—height heat flux deviation coefficient; σ₀ as Boltzmann radiation constant; a_{xi as} system radiation blackness; aₚ as panel-interval gas blackness; Hₚ as panel-interval gas radiation area; θₚ as panel-interval gas temperature between panels; t₃ as ash surface temperature;
c. calculating the average front radiation heat of the panel, Q_{q}:
Q_{q}=ξ_{q}Kₕσ₀aₓᵢa_{q}H_{q}[(θ_{q}+273)⁴−(t₃+273)⁴] (3)
wherein ξ_{q as} front radiation deviation coefficient of panels; Kₕ as height heat flux deviation coefficient; σ₀ as Boltzmann radiation constant; a_{xi as} system radiation blackness; a_{q} as gas chamber blackness before panels; H_{q} as front radiation area; θ_{q} as front gas chamber temperature, t₃ as ash surface temperature;
d. calculating the average before-front gas radiation heat, Q_{qq}:
Q_{qq}=ξ_{qq}Kₕσ₀aₓᵢa_{qq}(1−x_{gp})(1−a_{q})H_{qq}[(θ_{qq}+273)^{4 as}(t₃+273)⁴] (4)
wherein ξ_{qq as} before-front radiation deviation coefficient; Kₕ—height heat flux deviation coefficient; σ₀—Boltzmann radiation constant; aₓᵢ—system radiation blackness; a_{qq as} before-front gas chamber blackness; x_{gp} as radiation angle coefficient from before-front gas chamber to panel entry tube row; a_{q} as front gas chamber blackness; H_{qq} as before-front radiation area of panel; θ_{qq as} before-front gas chamber temperature; t₃ as ash surface temperature;
e. calculating the average in-panel gas radiation heat, Q_{z}:
Q=ξ_{z}Kₕσ₀aₓᵢa_{z}H_{z}[(θ_{z}+273)^{4 as}(t₃+273)⁴] (5)
wherein ξ_{z} as in-panel radiation deviation coefficient; Kₕ as height heat flux deviation coefficient; σ₀ as Boltzmann radiation constant; aₓᵢ as system radiation blackness; a_{z} as in-panel gas chamber blackness; H_{z} as in-panel radiation area; θ_{z} as in-panel gas chamber temperature; t_{3 as} ash surface temperature;
f. calculating the average back radiation heat, Qₕ,
Qₕ=ξₕKₕσ₀aₓᵢaₕHₕ[(θₕ+273)⁴−(t₃+273)⁴] (6)
wherein ξₕ as deviation coefficient of back radiation; Kₕ as height heat flux deviation coefficient; σ₀ as Boltzmann radiation constant; aₓᵢ as system radiation blackness; a_{h as} back gas chamber blackness; Hₕ as back radiation area; θₕ as back gas chamber temperature; t₃—ash surface temperature;
g. calculating the average underneath radiation heat, Qₓ:
Qₓ=ξₓKₕσ₀aₓᵢaₓHₓ[(θₓ+273)⁴−(t₃+273)⁴] (7)
wherein ξₓ as underneath radiation deviation coefficient; Kₕ as height heat flux deviation coefficient; σ₀ as Boltzmann radiation constant; aₓᵢ as system radiation blackness; aₓ as underneath gas blackness from furnace or gas chamber; Hₓ as underneath radiation area; θ_{x as} underneath gas temperature; t₃ as ash surface temperature;
h. calculating the enthalpy increment Δiₐ in the tube segment,
Δiₐ=Kᵣ^{y}(Q_{d}+Qₚ+Q_{q}+Q_{qq}+Q_{z}+Qₕ+Qₓ)/ga (8)
where—Kᵣ^{y} as width heat absorption deviation in pre-calculation; Q_{d} as average convection heat of the tube; Qₚ as average panel-interval gas radiation heat; Q_{q} as average front radiation heats; Q_{qq} as average before-front radiation heat; Q_{z} as average in-panel radiation heat; Qₕ as average back radiation heat; Qₓ as average underneath radiation heat; ga as steam flow of calculated tubes;
i. calculating the steam enthalpy i of the tube:
i=iⱼ+ΣΔiᵢ (9)
where: iⱼ as inlet steam enthalpy of the calculated tube segment, using the design parameters; ΣΔiᵢ as sum of all steam enthalpy increments calculated for all the tube segments from the tube inlet to the calculated points;
j. calculating the working medium temperature in the calculated tube segments, t: using the Enthalpy-Temperature diagram or table, obtain t based on i;
k. calculating the maximum heat flux along the tube outer periphery of the segment, qₘ:
qₘ+ηQ_{d}/H+φ(Qₚ/Hₚ+Q/H_{q}+Q_{qq}/H_{qq}+Q_{z}/H_{z}+Qₕ/Hₕ+Qₓ/Hₓ) (10)
wherein η as magnifying coefficient of convectional heat flux; Q_{d} as convectional heat; H_{d} as convectional heat absorption area; φ as heat radiation exposure coefficient; Qₚ as panel-interval gas radiation heat; Hₚ as panel-interval gas radiation area; Q_{q} as front radiation heat; H_{q} as front radiation area; Q_{qq} as before-front radiation heat; H_{qq} as before-front radiation area; Q_{z} as in-panel gas radiation heat; H_{z} as in-panel radiation area; Qₕ as back radiation heat; H_{h as} back radiation area; Qₓ as underneath radiation area; Hₓ as underneath radiation area;
l. calculating the inner wall temperature of the tube segments, t_{nb}:
t_{nb}=t+βqₘ(μₙ/α₂) (11)
wherein t as working medium temperature at calculated segments; β as ratio of outside diameter to inner diameter; μₙ as heat flux diversion coefficient at inner surface; α₂ as heat transfer coefficient from inner surface to steam; qₘ as maximum heat flux along tube's out periphery;
m. calculating wall temperatures of the tube segments t_{b} (at the points halving thermal resistance),
t_{b}=t+βqₘ[μₙ/α₂+δμₚⱼ/λ(1+β)] (12)
wherein t as working medium temperature of calculated segment; β as ratio of outer diameter to inner diameter; qₘ as maximum heat flux along tube segment outer periphery; μₙ as heat flux diversion coefficient at inner surface; μₚⱼ as average heat flux diversion coefficient through the wall thickness; α₂ as heat transfer coefficient from inner surface to steam; λ as conduction coefficient of the metal; δ as tube wall thickness;
n. calculating the metal allowable temperature of the monitored tube t_{yx},
t_{yx}=f(σ_{dt}) (13)
wherein σ_{dt} as stress of tube segment at calculated point;
o. calculating the wall temperature margin δt as per the allowable stress of tube metal,
δt=t_{yx}−t_{b} (14)
wherein t_{b} as wall temperature at the points halving thermal resistance; t_{yx} as allowable temperature of tube metal.

4. The method according to claim 3, wherein the average convective heat of the tube segment Q_{d} in step a is calculated according to the position of the calculated tube segments in the panel, determine the convection heat transfer deviation coefficient ξ_{d} of each row due to the convection heat transfer deviation caused by gas flushing.

5. The method according to claim 3, wherein the panel-interval gas radiation deviation coefficient in step b is calculated based on the angle coefficients from panel-interval gas chamber to the segments at different positions as the front tube, the medial tubes, tubes nestled up against sides of panel, tubes with different pitches at both sides.

6. The method according to claim 3, wherein the front radiation deviation coefficient of panels in step c is calculated based on the positions of tube segment stream-wise as 1^{st}, 2^{nd}, 3^{rd}, . . . row and the angle coefficients from the front gas chamber to calculated segment.

7. The method according to claim 3, wherein: the before-front radiation deviation coefficient in step d is calculated based on the angle coefficient from before-front gas chamber, as previous panel-interval gas chamber upstream, through the front gas chamber and entry tube row plane to calculated tube segments.

8. The method according to claim 3, wherein the in-panel radiation deviation coefficient in step e is calculated based on the positions of tube segment stream-wise as 1^{st}, 2^{nd}, 3^{rd}, . . . row and the angle coefficients from the in-panel gas chamber to calculated segment.

9. The method according to claim 3, wherein the deviation coefficient of back radiation in step f is calculated based on the positions of tube segment stream-wise as 1^{st}, 2^{nd}, 3^{rd}, . . . row and the angle coefficients from the back gas chamber to calculated segment.

10. The method according to claim 3, wherein the underneath radiation deviation coefficient in step g is calculated based on the positions of tube segment stream-wise as 1^{st}, 2^{nd}, 3^{rd}, . . . row and the angle coefficients from the underneath gas chamber to calculated segment.

11. The method according to claim 2, wherein the procedure for choosing the measured tubes by pre-calculation stated in Step 1 comprising the following steps:
\textcircled{1} through pre-calculation to seek out the tubes which are the most likely to suffer from bursts due to overheat;
\textcircled{2} ascending sort the tube wall temperature margins, and the Invention choose the first 100 tubes needed to be monitored, which are with the narrowest margins and scattered along the width and depth of boiler gas duct.

12. The method according to claim 11, wherein 5-20% of the total tubes in boiler from the above chosen 100 tubes are selected to install out-furnace wall temperature measured points as the layout of the measured points.

13. The method according to claim 1, wherein the procedure of saving data to communication database at local server in step 2 comprising the following steps:
\textcircled{1} choosing the boiler real-time operating data, lists of monitored points of out-furnace wall temperature in superheaters and reheaters from the KKS list supplied by the plants;
\textcircled{2} composing a program to collect data through API interface, send commands to the local computing server to request the real-time database to read data as per the list of monitored points and produce data files according to specified format;
\textcircled{3} sending the requested data twice per minute by the plant real-time database and saving them with assigned file name to the assigned location of the local computing server;
\textcircled{4} saving the data timely to the real-time database of the local server or the communication database.

14. The method according to claim 1, wherein calculating the working medium temperatures and the tube wall temperatures in real-time in step 3 comprising the following steps:
\textcircled{1} calculating the real-time working medium temperature, inner wall temperature and wall temperatures at the points halving thermal resistance of the monitored tube segments of all panels in boilers;
\textcircled{2} calculating the overheat as per the allowable stress of tube metal;
\textcircled{3} displaying the working medium temperatures, wall temperatures (at the points halving thermal resistance), the overheat as per the allowable stress of tube metal, overheat and material specifications of monitored tube segments of superheaters and reheaters in boilers with line chart, vector diagram and histogram combining the mouse pointer respond mode.

15. The method according to claim 14, wherein calculating the real-time working medium temperature, the inner wall temperatures and the wall temperatures of the calculated tube segments in step\textcircled{1} comprising the following steps:
a. calculating the average convection heat Q_{d} of the tube segment; the average panel-interval radiation heat, Qₚ; the average front radiation heat Q_{q}; the average before-front radiation heat, Q_{qq}; the average in-panel radiation heat Q_{z}; the average back radiation heat Qₕ; the average underneath radiation heat, Qₓ, of the calculating tube segments;
b. calculating the width deviation coefficient Kᵣ of heat absorption in actual operating conditions:
Kᵣ=Qⱼₛ/Qₚⱼ (15)
where: Qⱼₛ: heat absorption of calculated panel, Qₚⱼ: average heat absorption of panels;
c. calculating the enthalpy increment of the tube, Δiₐ:
Δiₐ=Kᵣ(Q_{d}+Qₚ+Q_{q}+Q_{qq}+Q_{z}+Qₕ+Qₓ)/ga (16)
where: Kᵣ; width heat deviation coefficient in real operating conditions; Q_{d} as average the convection heat; Qₚ as average panel-interval radiation heat; Q_{q} as the average front radiation heat; Q_{qq} as average before front radiation heat; Q_{z as} average in-panel radiation heat; Qₕ as average back radiation heat; Q_{x as} average underneath radiation heat; ga as steam flow of the calculated tube segment;
d. calculating steam enthalpy i and temperature t of working medium of tube segment:
i=iⱼ+ΣΔiᵢ (17)
where: iⱼ as inlet steam enthalpy of the panel during operation; ΣΔiᵢ as sum of calculated steam enthalpy increments of all the tube segments from its inlet to the monitored point.
e. determine the working medium temperature t at monitored point: finding the temperature t based on the enthalpy i using an enthalpy-temperature diagram or table;
f. calculating the maximum local heat flux qₘ around the outer periphery of the tube;
g. calculating the wall temperatures t_{nb} at inner surface of the monitored point and wall temperature t_{b}.

16. The method according to claim 14, wherein calculating the overheat as per the allowable stress of tube metal in step\textcircled{2} comprising the following steps:
a. calculating the allowable metal temperature t_{yx} at given stress:
t_{yx}=f(σ_{dt}) (18)
where: σ_{dt} as the stress of the tube at the calculated point;
b. calculating the overheat dt as per the allowable stress of tube metal:
dt=t_{b}−t_{yx} (19)
where: t_{b} as wall temperature; t_{yx} as allowable temperature of tube metal.

17. The method according to claim 1, wherein displaying the working medium temperatures, wall temperatures, the overheat as per the allowable stress of tube metal, overheat and material specifications of monitored tube segments of superheaters and reheaters in boilers in step \textcircled{3} refers to the user choosing the option as “Displaying the distribution profiles of steam temperature and wall temperature” in format of ‘all panels’ or ‘all tubes in a panel’ from the menu of “Steam temperature monitor and alarm”. The screen would show the chosen distribution profiles of steam temperatures and wall temperatures respectively. Once there appeared overheat as per the allowable stress, the corresponding graphic figures would change color from blue to red for alarming; when the mouse pointer is clicked on a bar graph, there would show the related data, such as the location, the medium temperature, wall temperature, overheat as per the allowable stress, the overheat, material and specification of the current tube segment.

18. The method according to claim 1, wherein saving into the comprehensive overheat database in step 4 refers to saving the recorded and displayed parameters including the accumulative overheat time-duration, overheat, overheat frequency and the parameters of the boiler operation at the moment when overheat happens, and comprising the following steps:
\textcircled{1} hourly recording all parameters related to the overheat as per the allowable stress would trigger into the database, including the boiler's power output, the main steam temperature, the highest wall temperature, the overheat time, material, specification, in order to be available for inquiring about the overheat statistics and analysis of tube bundles;
\textcircled{2} composing desired scatter point diagram, vector diagram, histogram and/or tabulation, while the overheat frequency, overheat, and the overheat time duration are taken as the ordinates and the panel serial numbers as abscissa, in order to illustrate the distribution profiles or tables of the overheat frequency, overheat amplitude, and overheat time for the first 100˜800 tube segments;
\textcircled{3} when mouse pointer overhangs on any scatter point, a data box will appear on screen which contains the information of location of the monitored tube segment, its material and specifications and the overheat time.

19. The method according to claim 1, wherein the distribution profiles in step 5 refer to the distribution profiles of the overheat value, overheat time and overheat frequency.
